(19) United States
(12) Patent Application Publication
(10) Pub. No.: US 2007/0103760 A1
(43) Pub. Date: May 10, 2007

(54) Optical Image Reading Device having Adjustable Amplification Rate and Method for Adjusting the same

(76) Inventor: Pen-Jung Lee, Sindian City (TW)

Correspondence Address: HDSL, 4331 STEVENS BATTLE LANE, FAIRFAX, VA, 22033, US

(21) Appl. No.: 11/620,496

(22) Filed: Jan. 5, 2007

Related U.S. Application Data
(62) Division of application No. 11/016,822, filed on Nov. 24, 2004.

(51) Int. Cl. G02F 1/03

(52) U.S. Cl. 359/245

(57) ABSTRACT

An optical image reading device that has an adjustable amplification rate and a method for adjusting the same. The optical image reading device includes a transparent object being disposed within the object distance or the image distance. Since the refractive index of the transparent object is larger than that of the air, the compensation and shrinkage of the object or image distances can be achieved accurately without changing the position of the lens and the electro-optical sensor. The amplification rate of the optical image reading device is thus accurately adjusted.

This application is a divisional application of U.S. patent application Ser. No. 11/016,822, filed on Nov. 24, 2004.

### BACKGROUND OF THE INVENTION

The present invention relates generally to an optical image reading device and a method for adjusting the same, and more particularly to an optical image reading device, the amplification rate of which can accurately be adjusted without changing the original design, thereby achieving the effect of compensation and shrinkage of the image or object distances.

Conventional optical image reading devices, such as a charge couple device module (CCDM), changes the amplification rate by adjusting the position of the lens and the electro-optical transformer (electro-optical sensor). As shown in FIG. 1, since the optical paths through the elements of conventional optical image reading device have certain errors during the manufacturing process, one always needs to shift the position of the lens 1a and the electro-optical sensor 2a for adjusting the object distance D between the lens 1a and the object to be scanned 3a, and the image distance d between the lens 1a and the electro-optical sensor 2a. Or, one can shift the electro-optical sensor 2a to adjust the object distance, thereby achieving the purpose of amplification rate adjustment.

However, if the amplification rate of the optical image reading device is adjusted by directly shifting the position of the lens 1a or the electro-optical sensor 2a, the modulation transfer function will also be affected, which renders the adjustment more complicated and time consuming.

In light of the above, the inventor of the present invention has devoted himself to the study of this problem, and developed a new optical image reading device that can solve the problem as set forth above.

### BRIEF SUMMARY OF THE INVENTION

The present invention is to provide an optical image reading device that has an adjustable amplification rate and a method for adjusting the same. The optical image reading device includes a transparent object being disposed within the object distance or the image distance. Since the refractive index of the transparent object is larger than that of the air, the compensation and shrinkage of the object or image distances can be achieved accurately without changing the position of the lens and the electro-optical sensor. The amplification rate of the optical image reading device is thus accurately adjusted.

In order to achieve the above and other objectives, the optical image reading device of the present invention scans the image of a scanned object. The optical image reading device includes a lens, an electro-optical device, and at least a transparent object. The distance between the lens and the scanned object defines the object distance, while the distance between the lens and the electro-optical device defines the image distance. The transparent object is disposed within the object distance or the image distance. Consequently, by changing the path of the scanning light through the transparent object, the required compensation or shrinkage of distance is achieved.

In order to achieve the above and other objectives, the amplification rate adjustment method includes the step of disposing at least a transparent object within the object distance that is defined by the distance between a lens and a scanned object, or within the image distance that is defined by the distance between a lens and an electro-optical element. Since the refractive index of the transparent object is larger than that of the air, the effect of compensation and shrinkage of the object distance or the image distance can be achieved.

### BRIEF DESCRIPTION OF THE DRAWINGS

FIG. 1 illustrates a conventional optical image reading device.

FIG. 2 illustrates an optical image reading device of the present invention.

FIG. 3 illustrates a transparent object being disposed within the object distance.

FIG. 4 is an enlarged view of part A in FIG. 3.

FIG. 5 illustrates a transparent object being disposed within the image distance.

FIG. 6 is an enlarged view of part A in FIG. 5.

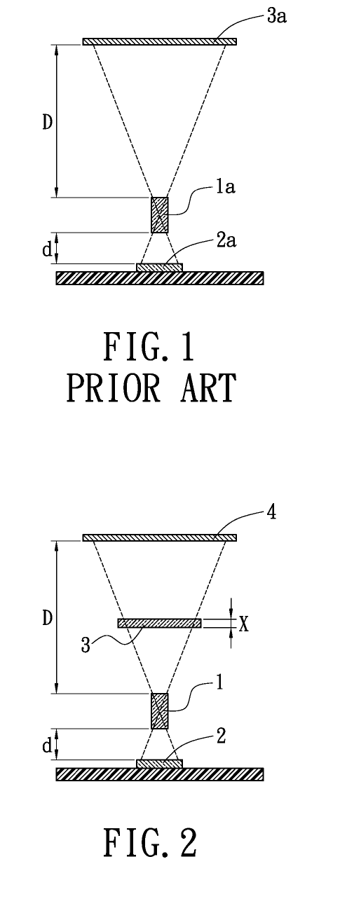

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

The present invention provides an optical image reading device having an adjustable amplification rate and method for adjusting the same. In the optical image reading device, at least a transparent object is inserted between the object distance or the image distance. Since the refractive index of the transparent object is larger than that of the air, the compensation, shrinkage of object or image distances can be achieved without changing the position of the lens and the electro-optical sensor. The amplification rate of the optical image reading device can thus be adjusted accurately.

As shown in FIG. 2, the optical image reading device of the present invention is illustrated. The optical image reading device is disposed in a scanner. The optical image reading device scans and captures the image of the scanned object 4. The optical image reading device includes a lens 1, an electro-optical element 2 and at least a transparent object 3. In the optical image reading device, the object distance D is defined as the distance between the lens 1 and the scanned object 4, while the image distance d is defined as the distance between lens 1 and the electro-optical element 2. The transparent object 3 is disposed within the object distance D or the image distance d and substantially parallel to the lens 1 and the electro-optical element 2. In addition, the transparent object 3 is made of any transparent material, such as glass, PC or PMMA.

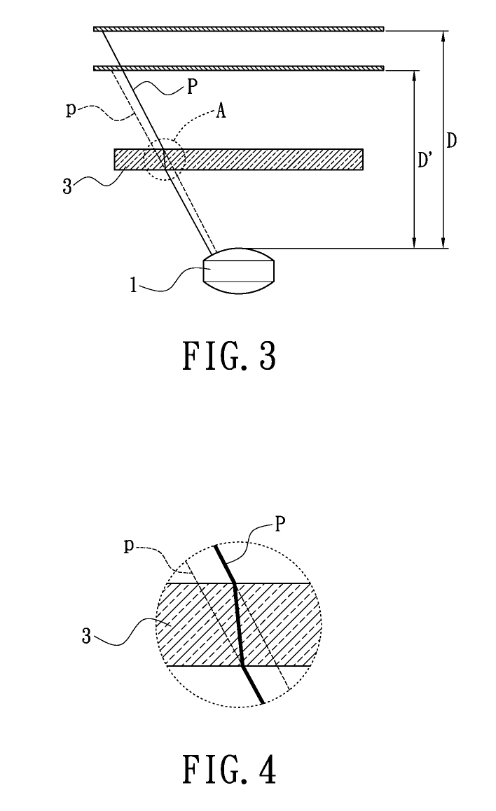

As shown in FIG. 3, the transparent object of the present invention being disposed within the object distance is illustrated. In this particular embodiment, the scanning light travels along path p, provided that there is no transparent object 3 present. Once the transparent object 3 is included, the scanning light then travels through the transparent object 3 along path P (as shown in FIG. 4.) Therefore, when the object distance D is the required real object distance, and assuming that D=151 mm, while the originally designed object distance D′=150 mm, there is apparently 1 mm of object distance to be compensated. Suppose that the transparent object 3 is made of PMMA material, the refractive index I of which is then 1.49. Thus, the thickness X of the transparent object 3 is defined as the following formula:
D′=(D−X)+(X/I)

Therefore, by substituting the above numbers into the formula, one obtains the thickness X=3.04 mm. Thus, the required compensation distance of the optical image reading device is calculated from the amplification rate. According to the required compensation distance and the refractive index of the transparent object 3, the required thickness of the transparent object 3 is obtained, thereby achieving the required compensation.

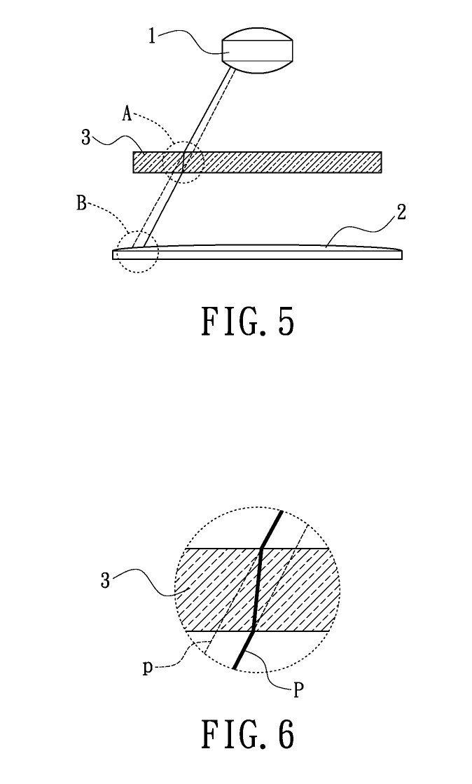

As shown in FIG. 5, the transparent object of the present invention being disposed within the image distance is illustrated. The transparent object 3 can also be disposed with the image distance d between the lens 1 and the electro-optical element 2. Similarly, the thickness X of the transparent object 3 can be derived from the following formula:
d′=(d−X)+(X/I)

Meanwhile, as shown in FIG. 6, the scanning light along the path P is refracted inward when inserting the transparent object 3. In other words, the detected points of the electro-optical device 2 are reduced, thereby decreasing the amplification rate. Accordingly, the amplification rated is decreased when disposing the transparent element 3 within the image distance.

Therefore, the amplification rate of the optical image reading device can be adjusted by either disposing the transparent object 3 within the object distance D or the image distance d, without adjusting the position of the lens 1 or the electro-optical device 2. This means that no substantial change of object distance D or image distance d is required. For this reason, the adjustment is quick and easy, and will not affect the modulation transfer function.

In summary, the present invention can indeed achieve the prospected purpose, and satisfies the novelty and non-obviousness requirement of the patent law, a grant of letters patent is thus respectively requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. An optical image reading device for scanning an image of a scanned object, the optical image reading device comprising a lens, an electro-optical element, and at least a transparent object, wherein the distance between the lens and the scanned object defines an object distance, while the distance between the lens to the electro-optical element defines an image distance, wherein the transparent object is disposed within the object distance or the image distance.

2. The optical image reading device as recited in claim 1, wherein the transparent object is made of glass.

3. The optical image reading device as recited in claim 1, wherein the transparent object is made of PC material.

4. The optical image reading device as recited in claim 1, wherein the transparent object is made of PMMA material.

5. The optical image reading device as recited in claim 1, wherein the transparent object is substantially parallel to the lens and the electro-optical element.
